(19) United States
(12) Patent Application Publication
(10) Pub. No.: US 2006/0279051 A1
(43) Pub. Date: Dec. 14, 2006

(54) Steering assembly for a trolley

(76) Inventor: Michael Stokes, Toorak (AU)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/564,042

(22) PCT Filed: Jul. 7, 2004
(86) PCT No.: PCT/AU04/00911

§ 371 Date: Aug. 1, 2006

(30) Foreign Application Priority Data
Jul. 9, 2003 (AU) 2003903553

(51) Int. Cl. B62D 39/00

(52) U.S. Cl. 280/33.991

(57) ABSTRACT

A steering assembly for use with a trolley including a carriage and at least one castor wheel (3) swivel-mounted about a vertical axis, the steering assembly including: co-operating wheel blocking members (131, 23) mounted respectively to the carriage and the castor wheel; and actuation means (150, 152) for causing the selective engagement of the co-operating wheel blocking members (131, 23) so as to prevent swivelling of the castor wheel (3).

### FIELD OF THE INVENTION

The present invention generally relates to steering assemblies for vehicles or apparatus fitted with castor wheels, and in particular to assemblies that assist in the steering of trolleys. The invention is suitable for use in controlling vehicles or apparatus fitted with castor wheels and particularly shopping trolleys, and it will be convenient to describe the invention in relation to that exemplary, non-limiting application.

### BACKGROUND OF THE INVENTION

Shopping trolleys generally include a load-bearing basket and handle mounted to a carriage. Four independent castor wheels are mounted to the carriage by swivel fittings so that each wheel is rotatable about a vertical axis, thereby allowing the trolley to be easily displaced in any horizontal direction.

The provision of four independently swivelling castor wheels is necessary to safely steer the shopping trolleys in some circumstances, such as when a series of stacked shopping trolleys are required to be displaced by supermarket employees. However, single shopping trolleys having such independently swivelling castor wheels are well known to be difficult for shoppers to steer. A shopper may have to manoeuvre the trolley in several sideways directions in order to attempt to control the trajectory of a trolley. The inability to adequately steer such trolleys not only causes inconvenience to shoppers but has often lead to third-party injury and property damage.

There exists a need to provide a steering assembly for castor wheel vehicles and particularly a trolley that ameliorates or overcomes one or more disadvantages of known trolley steering systems. It would be desirable to provide a steering assembly that is easily operable by the shopper or other trolley user. It would also be desirable if the steering assembly was capable of being retro-fitted to existing trolleys without a need to significantly modify the structure of the trolley frame or castor wheels themselves. It would furthermore be desirable to provide a steering assembly that was simple to manufacture, fit and/or maintain.

### SUMMARY OF THE INVENTION

In the context of this invention, reference to a trolley is not only intended to refer to shopping trolleys but also other apparatus with castor wheels which need to be engageably locked in position and unlocked.

The present invention provides a steering assembly for use with a trolley, the trolley including a carriage and at least one castor wheel swivel-mounted about a vertical axis, the steering assembly including:

co-operating wheel blocking members mounted respectively to a fixed mounting on the carriage or a wheel mounting assembly, and the castor wheel; and

actuation means for causing the selective engagement of the co-operating wheel blocking members so as to prevent swivelling of the castor wheel.

The wheel blocking members may include a first blocking member comprising a ferrule having a recess, and a second blocking member comprising a pawl for engagement in that recess. One of the wheel blocking members, such as the first blocking member may be mounted about the vertical axis of the castor wheel.

The castor wheel may be mounted to the wheel mounting assembly which in turn is mounted to the carriage.

In one embodiment, the second wheel blocking member, such as the male member, may be indirectly mounted to the carriage by means of a bracket slidably mounted to the carriage or wheel mounting assembly. The bracket may be slidably movable between a first position in which the bracket facilitates engagement of the wheel blocking members, and a second position in which the bracket prevents engagement of the wheel blocking members.

The steering assembly may further include actuation means for causing displacement of the bracket between the first and second position. The actuation means may include a cam lever pivotably mounted to the carriage and bearing upon the bracket upon rotation of the cam to displace the bracket towards the second position.

The actuation means may further include a pushing mechanism, such as a pushing plate provided at one end of the bracket to enable the bracket to be slidably moved to the second position. The pushing plate may be integrally formed with the bracket.

One or both of the cam lever and the pushing mechanism may be operable by contact with an adjacent trolley.

The steering assembly may further include biasing means for biasing the bracket towards the first position. The biasing means may include one or more resilient members mounted between the bracket and the carriage.

In another embodiment, the second wheel blocking member may be directly mounted to the carriage or wheel mounting assembly. The castor wheel may be mounted so as to be movable relative to the carriage or wheel mounting assembly between a first position in which the bracket facilitates engagement of the wheel blocking members, and a second position in which the bracket prevents engagement of the wheel blocking members.

The carriage and the castor wheel may be caused to move towards the first position by the application of force to the carriage. The force may be applied by the placement of goods in the carriage.

In a further embodiment, the second wheel blocking member may be pivotably mounted to the carriage or wheel mounting assembly so as to be movable between a first position causing engagement of the wheel blocking members and a second position in which engagement of the wheel blocking members is prevented.

The second wheel blocking member may be pivotably mounted to the carriage or wheel mounting assembly by means of a latching mechanism. The latching mechanism may include a latch device for retaining the second wheel blocking member in either the first or second position.

The second wheel blocking member may be provided with a first arm for engagement with the recess and a second arm for engaging the latching device. The engagement of the second arm with the latch device preferably retains the wheel bocking members in the disengaged position. The latch device may include a magnet. In a preferred form, the latching device includes a latching plate.

The second blocking member may be actuated by contacting the first arm, causing pivotal movement of the second blocking member and causing engagement of blocking members. The blocking members are disengaged by contacting the second arm and engaging the second arm with latching device to retain the second blocking member in position.

The actuation means may include a peddle member projecting from the other wheel blocking member. The peddle member may be latched in the first or second position by the latch device. Depression of the peddle member may release the second wheel blocking member and cause engagement of the wheel blocking members.

The second wheel blocking member may return to a position causing engagement of the wheel blocking members by action of gravity.

The actuation means may further include an actuation member slidably mounted to the carriage for movement between a first position causing a disengagement of the wheel blocking members and a second position in which engagement of the wheel blocking members is enabled. Movement of the actuation member from the second to the first position may cause pivotal movement of the second wheel blocking member to a position engaging the latch device.

The steering assembly may further include a biasing arrangement for biasing the carriage and bracket towards the second position. The biasing arrangement may include one or more resilient members mounted between the castor wheel and the carriage.

The invention also provides a trolley including the above described steering assembly.

### DETAILED DESCRIPTION OF PREFERRED EMBODIMENT

Embodiments of the present invention will now be described, by way of example only, with reference to the drawings. However, it is to be understood that the following description is illustrative only and should not be taken in any way as a restriction on the generality of the invention that is described herein.

In the drawings:

FIG. 1 is a side view of a steering assembly in accordance with a first embodiment of the present invention in a first operable position;

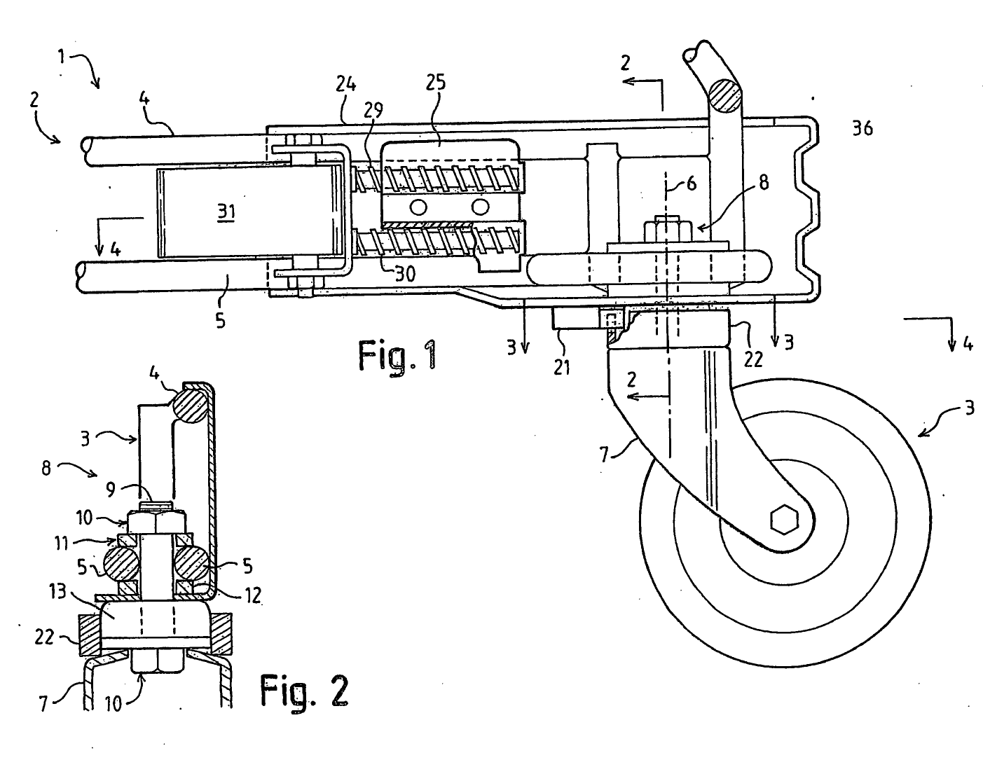

FIG. 2 is a cross sectional plan view of part of the steering assembly of FIG. 1;

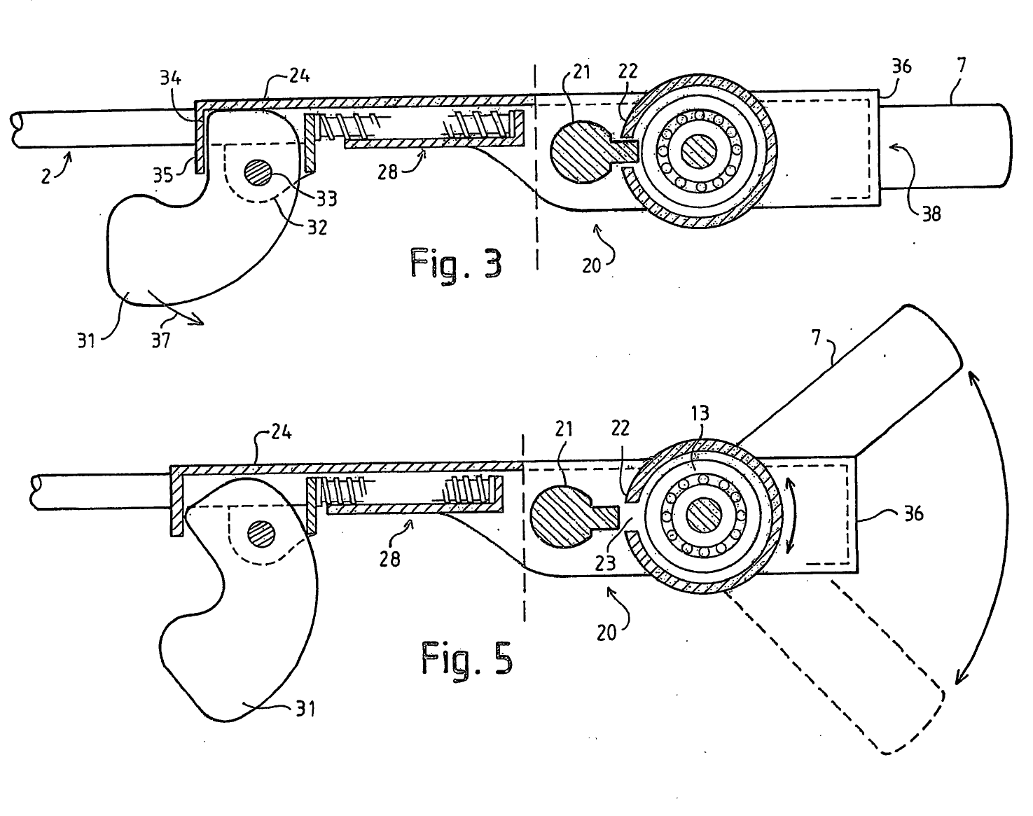

FIG. 3 is a cross sectional plan view of the steering assembly shown in FIG. 1;

FIG. 4 is a side view of the steering assembly of FIG. 1 in a second operable position;

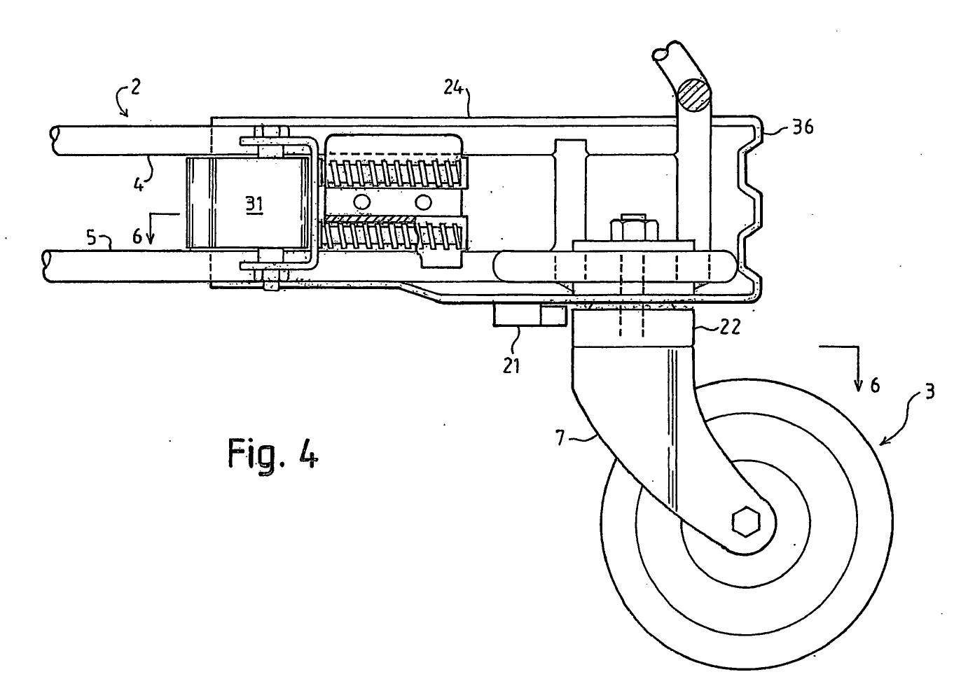

FIG. 5 is a cross sectional plan view of the steering assembly shown in FIG. 5; and

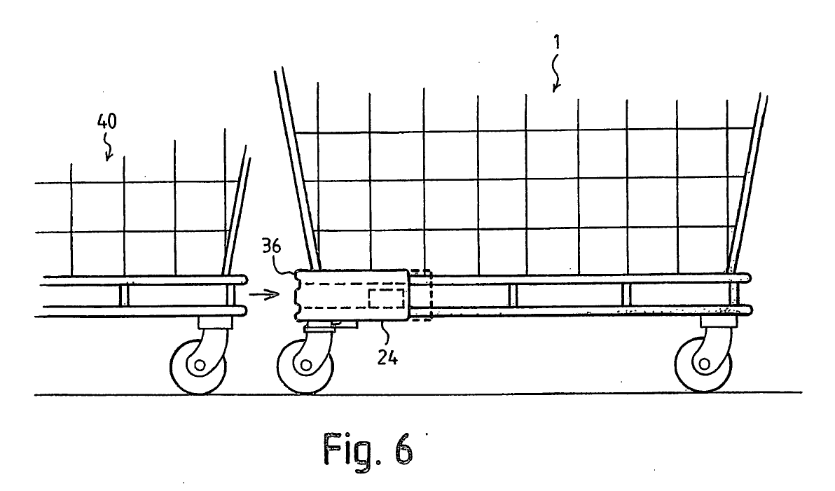

FIG. 6 illustrates an exemplary application of the steering assembly to shopping trolleys.

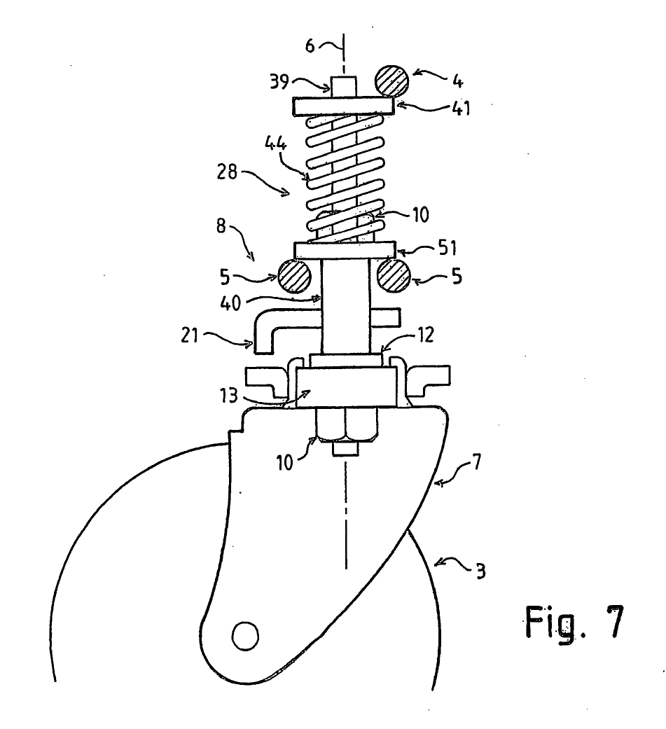

FIG. 7 is a side view of a steering assembly in accordance with a second embodiment of the present invention;

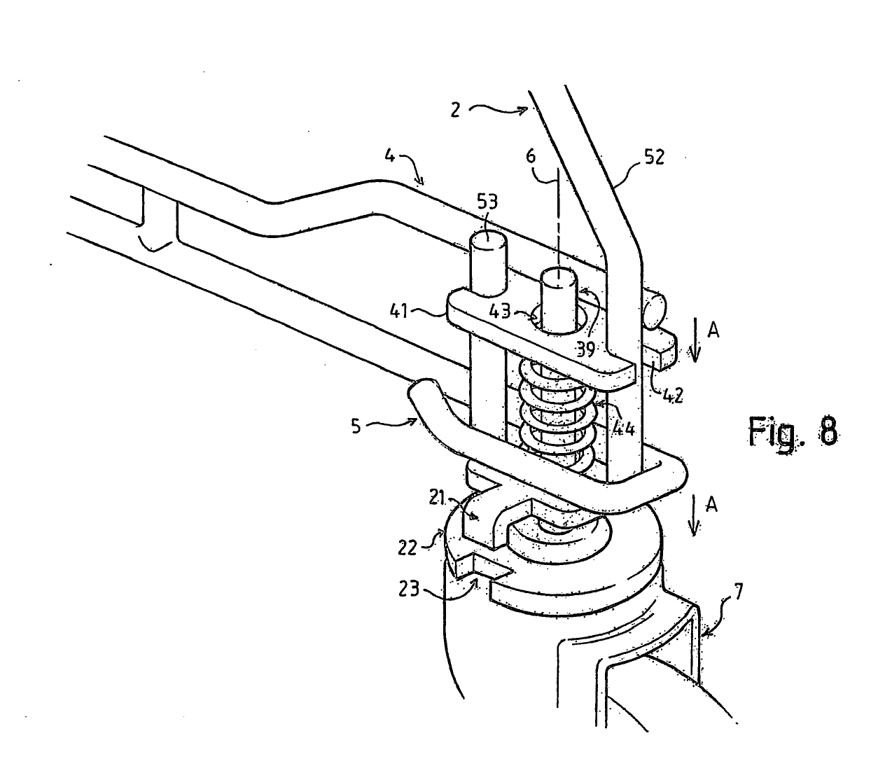

FIG. 8 is a perspective view of the steering assembly of FIG. 7;

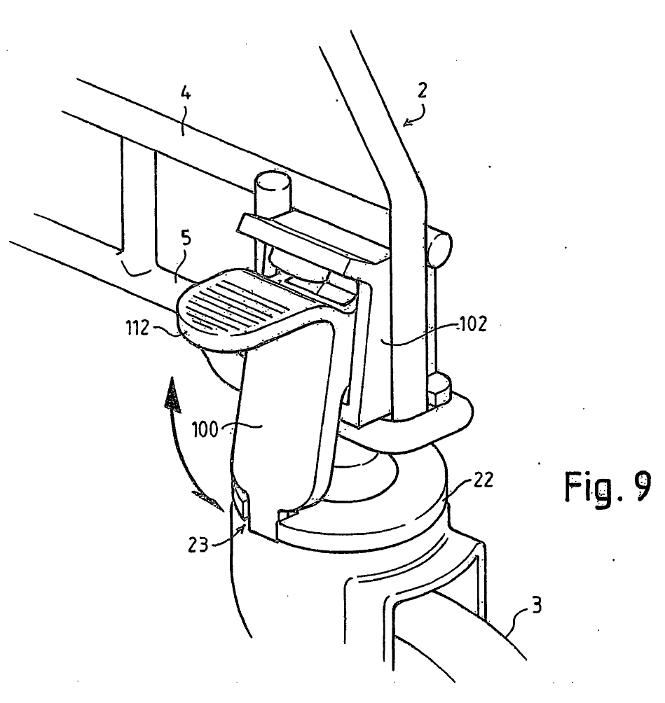

FIG. 9 is a perspective view of a third embodiment of a steering assembly in accordance with the present invention;

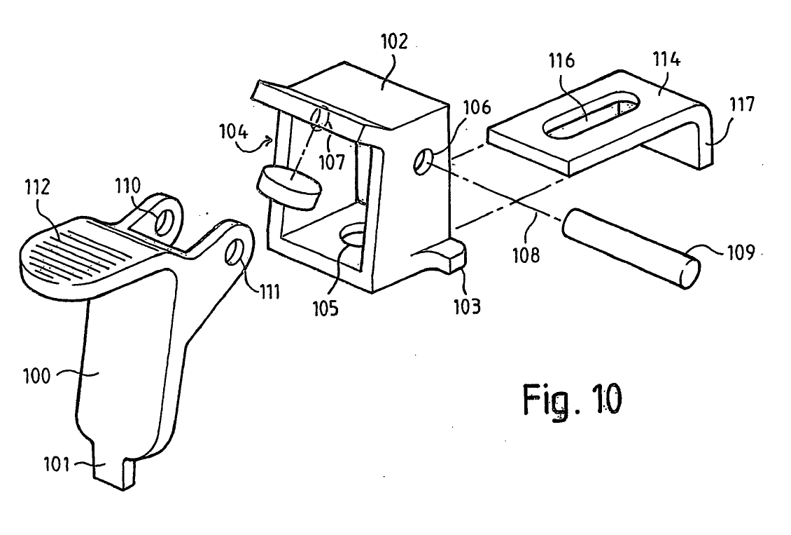

FIG. 10 is an exploded perspective view of various components forming part of the steering assembly shown in FIG. 9;

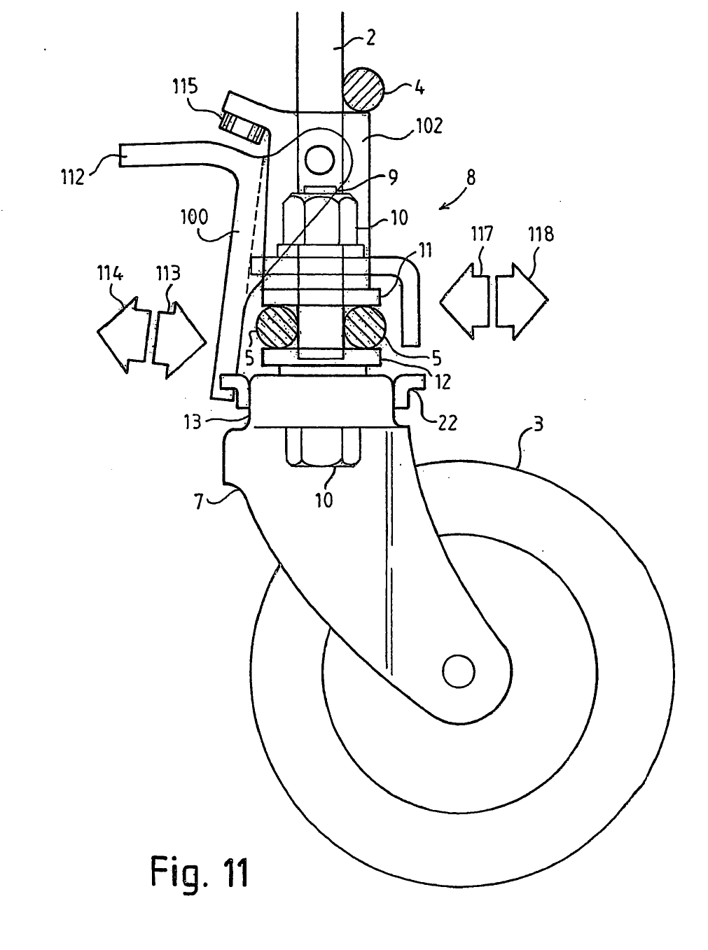

FIG. 11 is a side view of the steering assembly shown in FIG. 9;

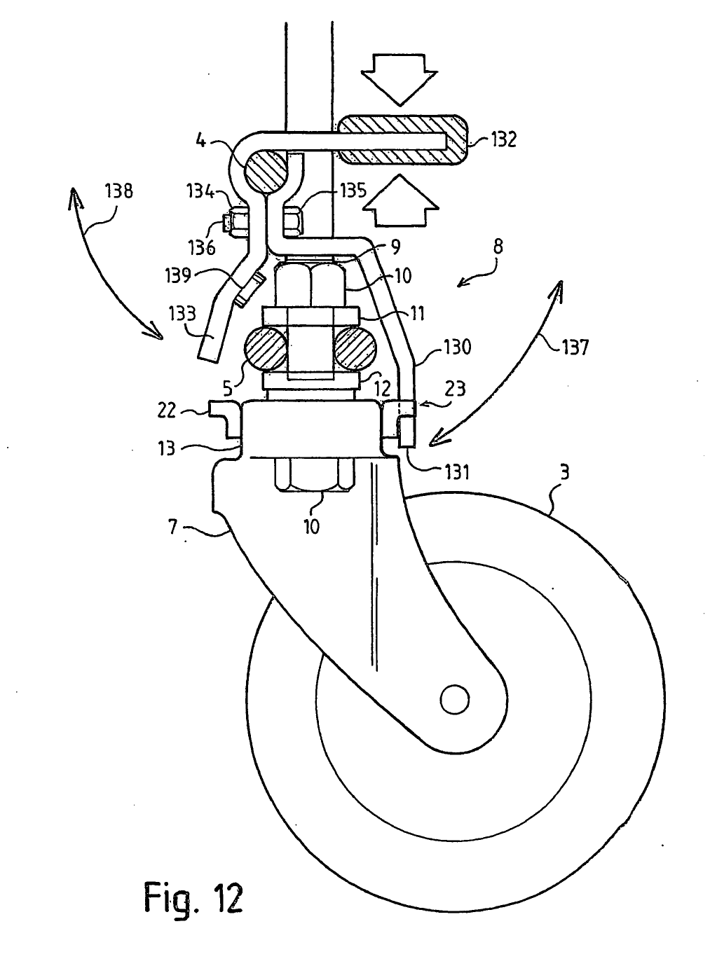

FIG. 12 is a side view of a fourth embodiment of a steering assembly in accordance with the present invention;

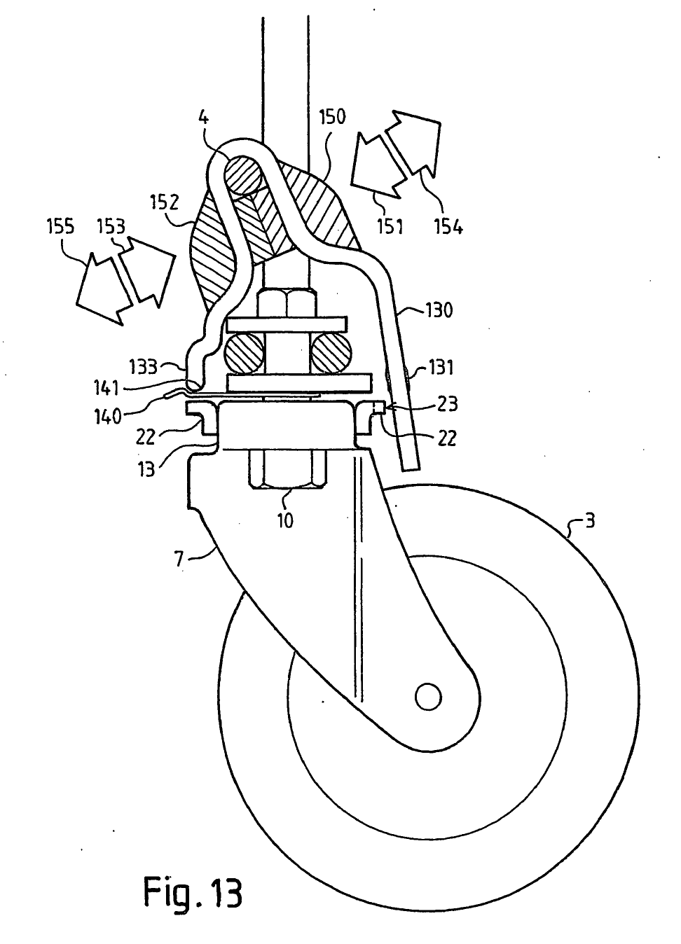

FIG. 13 is a side view of a fifth embodiment of the steering assembly in accordance with the invention;

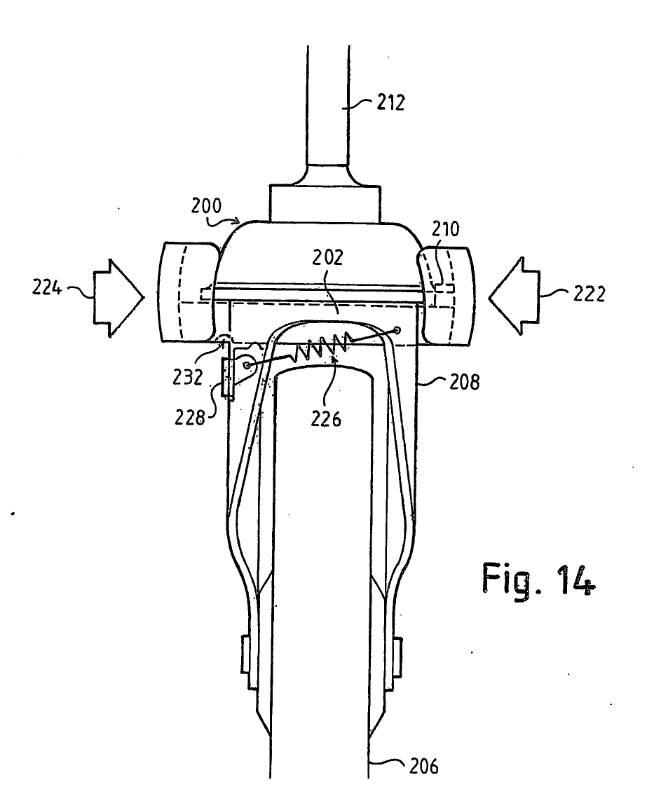

FIG. 14 is a side view of a sixth embodiment of the steering assembly in accordance with the invention;

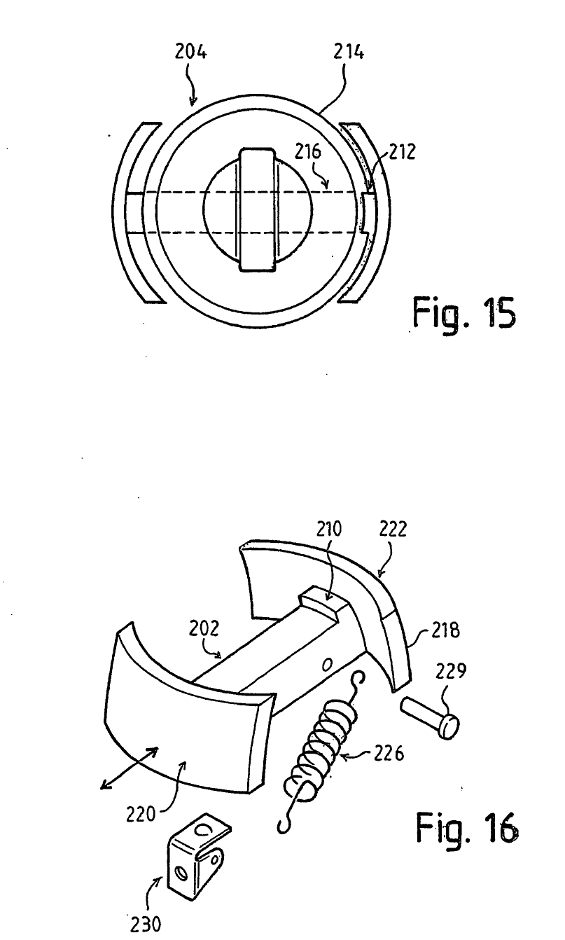

FIG. 15 is a plan sectional view through line 15-15 of FIG. 14; and

FIG. 16 is a view of the shuttle of FIG. 14.

Referring now to FIG. 1, in a first embodiment, there is shown generally a portion of a known shopping trolley 1 including a carriage 2 and a castor wheel 3. The shopping trolley 1 generally includes four such castor wheels mounted at different locations to the carriage 2. The carriage 2 comprises frame members 4 and 5. The castor wheel 3 is swivel mounted to the frame member 5 of the carriage 2 about a vertical axis 6. The castor wheel 3 includes a skirt 7 mounted to the frame member 5 by means of a mounting assembly 8. As seen in FIG. 2, the mounting assembly 8 includes a bolt 9 and restraining nuts 10. Mounting plates 11 and 12 placed on opposite sides of the frame member 5 ensure that upon tightening of the restraining nuts 10, the mounting assembly is fixedly attached to the frame member 5. A roller bearing assembly 13 is rotatably mounted about the bolt 9 and fixedly attached to the skirt 7 in order to enable the swivelling movement of the castor wheel about the vertical axis 7. The roller bearing assembly 13 is maintained in position between the retaining bolt 11 and the mounting plate 12.

The steering assembly in one embodiment of the present invention includes a wheel blocking arrangement 20 that is selectively actuable to prevent swivelling of the castor wheel. As seen in FIG. 3, the wheel blocking arrangement 20 includes cooperating male and female members, respectively referenced 21 and 22. In this case, the female member 22 is constituted by a ferrule mounted about the roller bearing assembly 13 of the castor wheel. In other embodiments, however, the female member may be mounted elsewhere on the trolley 1. The ferrule 22 includes a recess 23 in which the male member 21 is able to engage. As the ferrule 22 is fixedly attached to the roller bearing assembly 13 of the castor wheel 3, engagement of the male member 21 in the recess 23 of that ferrule prevents the swivelling of the castor wheel 3.

The steering assembly further includes an adjustment means in the form of a bracket 24 slidably mounted to the frame members 4 and 5 of the trolley carriage 2. The bracket 24 is mounted to the frame members 4 and 5 by means of a mounting plate 25 and two securement bolts 26 and 27. The bracket is slidable along the frame members 4 and 5 of the carriage 2 between a first position, as shown in FIGS. 1 and 3, and a second position as shown in FIGS. 4 and 5. The male member 21 is mounted to or integrally formed with the bracket 24 so that in the first position the male member 21 is engaged in the recess 23 of the ferrule 22, and in the second position is retracted from the recess 23 so as to enable swivelling movement of the castor wheel 3 about the vertical axis 6.

A biasing arrangement 28 is provided to bias the bracket 24 towards the first position illustrated in FIGS. 1 and 3. In the example illustrated, the biasing arrangement includes two springs 29 and 30, or other resilient members, fixedly attached at either end respectively to the mounting plate 25 and the carriage 2.

The steering assembly 1 further includes actuation means for causing displacement of a bracket from the first position to the second position. To that end, the illustrated example includes a cam lever 31 pivotally connected to a laterally projecting portion 32 of the carriage 2 about a pivot point 33 distal from the plane of the bracket 24. The cam lever 31 includes an abutment portion 34 for bearing against an abutment surface 35 of the bracket 24 upon rotation of the cam lever 31. The actuation means may also include a pushing plate 36 laterally projecting from the bracket 24 so that upon pushing the pushing plate 36 towards the carriage 2, the bracket 24 is caused to be displaced towards the second position.

When in use, the steering assembly may be in the first position shown in FIGS. 1 and 3. In this position, no force is applied to either the cam lever 31 to cause the rotation of the cam lever, or to the pushing plate 36. The biasing arrangement 28 therefore causes displacement of the bracket towards the first position and upon the castor wheel adopting a position substantially in line with the direction of travel of the trolley, the recess 23 of the ferrule 22 and the male member 21 become aligned, and the male member 21 is caused to engage in the recess 23. It will be appreciated that in this arrangement, the biasing arrangement 28 causes the male member 21 to act as a pawl so that upon alignment of the male member 21 and recess 23, the male member is automatically inserted into the recess.

A shopping trolley having steering assemblies mounted to the rear castor wheels has been found to be advantageous to a shopper using an individual trolley, as the ordinary usage of the trolley causes the castor wheels to become aligned with the direction of travel of the trolley. When this occurs, the steering assembly of the present invention acts to automatically prevent swivelling of those rear castor wheels, thereby facilitating control of the shopping trolley.

However, upon the application of a rotational force to the cam lever 31 in the direction indicated by the reference arrow 37, the abutment portion 34 of the cam lever 31 is caused to bear against the abutment surface 35 of the bracket 24, and cause displacement of the bracket towards the second position shown in FIGS. 4 and 5. Should the force applied be sufficient to overcome the opposing force of the resilient members 29 and 30 of the biasing arrangement 28, the bracket 24 will move towards the second position, thereby disengaging the male member 21 from the recess 23 of the ferrule 22. Accordingly, the free swivelling of the castor wheel 7 about the vertical axis 6 will no longer be prevented.

A similar result is obtained upon application of a force in the direction of the reference arrow 38 to the pushing plate 36.

One or both of the cam lever 31 and the pushing plate 36 may be mounted to the carriage 2 in a location so as to be operable by contact with an adjacent or abutting shopping trolley. As shown in FIG. 6, the stacking of supermarket trolleys inside each other can result in the application of a suitable force to either the pushing plate 36 of the bracket 24, or the cam lever 31 of the steering assembly, from an adjacent shopping trolley. With this arrangement, several shopping trolleys may be stacked inside each other, the application of force to the steering assembly of a first trolley by an adjacent trolley resulting in the operation of the actuation means and the subsequent displacement of the bracket 24 from the first position in which the rear blocking means are actuated, to the second position in which the swivelling of the castor wheel is no longer prevented. Such an arrangement is particular advantageous in controlling the trajectory of a number of supermarket trolleys stacked inside each other.

Referring now to FIG. 7, there is shown an alternate form of the steering assembly of the present invention. In this embodiment however, a strut 39 is secured to the roller bearing assembly 13 and the skirt 7 of the caster wheel 3 by the restraining nut 10. A sleeve 40 houses the strut 39. The sleeve 40 includes a flange 51 at its upper extremity.

A bearing plate 41 is secured to the frame member 4 and comprises recesses 42 on opposed ends to receive and guide frame members 52 and 53. A centre aperture 43 in the bearing plate 41 receives the strut 39, as shown in FIG. 8. A biasing arrangement 28, including a resilient member such as a spring 44, is provided to bias the carriage 2 towards the position shown in FIGS. 7 and 8. The spring 44 is mounted between the flange 51 and bearing plate 41.

A wheel blocking arrangement 20 is provided, similar to the one described in the previous embodiment. A male member 21 is secured or integrally formed with the frame member 5 and a female member 22 is fixedly attached to the roller bearing assembly 13 of the castor wheel 3. As described earlier, the female member 22 in this example is a ferrule having a recess 23 to engage the male member 21 and thus prevent swivelling of the castor wheel 3.

In this example, pushing down or applying weight to the carriage 2 of the trolley causes the biasing arrangement 28 to be compressed and the carriage 2 to be displaced in the direction indicated by reference arrows A. Consequently, the swivelling movement of the castor wheel is blocked when the male member 21 engages with the female ferrule 22.

In operation, when the trolley is not in use, the steering assembly may be in the position as shown in FIG. 8, where no force or weight is applied to the carriage. In this case, the spring 44 is uncompressed and the male member 21 is not engaged in the ferrule 22 thereby allowing swivelling movement of the castor wheel about an axis 6.

When a force or weight is applied to the carriage 2, such as pushing down or placement of items in the trolley, the spring 44 is compressed and, upon the castor wheel adopting a position substantially in line with the direction of travel of the trolley, the recess 23 of the ferrule 22 and the male member 21 become aligned and the male member 21 is caused to engage in the recess 23. In this first position, the castor wheel is prevented from swivelling and the trolley may be easily steered.

To enable swivelling movement of the castor wheel, weight is removed from the trolley, which releases the tension applied on spring 44, thereby returning the carriage 2 and frame members 4 and 5 to the second position and disengaging the male member 21 from the ferrule 22.

The tension in the spring 44 is set at a rate which allows the placement of a few items in the trolley or the application of slight downward pressure on the carriage to enable the wheels to be locked. The tension rate may be set at any rate depending on the type of trolley and its use.

Referring now to FIG. 9, there is shown a third embodiment of the steering assembly of the present invention. As in the first embodiment, the mounting assembly 8 mounts the castor wheel to the carriage by means of a bolt 9, restraining nuts 10 and mounting plates 11 and 12 placed on opposite sides of the frame member 5 so that upon tightening of the restraining knots, the mounting assembly is fixedly attached to the frame member 5. Similarly, a ferrule 22 is mounted about the roller bearing assembly 13 of the castor wheel 3.

The steering assembly shown in FIGS. 9 to 11 includes a male member 100 including a pawl 101 for engagement in a recess 23 in the ferrule 22. The male member 100 is shown as being pivotally mounted to the carriage 2 by means of a latching mechanism 102. It is within the scope of the invention that the male member is mounted to a wheel mounting assembly and hence, indirectly mounted to the carriage. The male member is movable between a first position, as shown in FIGS. 9 and 11, in which the pawl 101 engages in the recess 23, and a second position in which engagement of the pawl 101 and the recess 23 is prevented. The latching mechanism 102 has the form of a box structure, and includes shoulder portions 103 and 104 for positioning the latching mechanism with respect to frame members of the carriage 2, and a through hole 105 through which the bolt 9 passes in order to secure the latching mechanism 102 to the carriage 2 upon tightening of the nuts 10.

The male member 100 is pivotally attached to the latching mechanism 102 at pivot points 106 and 107 about a pivot axis 108 by means of a rod member 109 passing through holes 110 and 111 in the male member and holes 106 and 107 in the latching mechanism.

A peddle member 112 projects laterally from the male member 100 in order to enable user operation of the steering mechanism. Depression of the peddle member 112 causes the pivotal movement of the male member 100 in the direction of the arrow 113 shown in FIG. 11 towards a position in which the pawl 101 engages in the recess 23 of the ferrate 22, thereby preventing swivelling of the castor wheel 3.

The steering assembly shown in FIGS. 9 to 11 further includes an actuation member 114 slidably mounted to the carriage for movement between a first position, shown in FIG. 11, in which engagement of the wheel blocking members is permitted, and a second position in which the actuation member bears against the male member 100 and causes pivotal movement of that member in the direction indicated by the arrow 114 so as to cause disengagement of the pawl 101 from the recess 23 thereby enabling a swivelling movement of the castor wheel 3 with respect to the carriage 2.

The latching mechanism 102 may include a latching device, such as a magnet 115. The latching device 115 acts to retain the peddle member 112, and hence the male member 100, in a latched position preventing engagement of the wheel blocking members.

As shown in FIG. 10, the actuation member 114 is in the form of a plate having an elongate recess 116 through which the bolt 9 passes. The elongate nature of the recess 116 delimits the sliding movement of the actuation member in the directions shown by the arrows 117 and 118; The actuation member also includes a flange portion 117 projecting from a rearwardly located end of the actuation member and arranged so as to be operable by contact with an adjacent or abutting shopping trolley. The stacking of shopping trolleys thereby causes movement of the actuation member in the direction indicated by the arrow 117, to thereby disengage the wheel blocking members and allow swivelling movement of the castor wheel 3 with respect to the carriage 2.

The arrangement shown in FIGS. 9 to 11 advantageously provides a shopping trolley user with a choice of either simply pivoting the male member 100 and peddle member 112 towards a latched position in which the castor wheel freely swivels with respect to the carriage 2, or alternatively enables the user to depress the peddle member 112 thereby causing engagement of the wheel blocking members so that the castor wheel 3 remains in a fixed orientation with respect to the carriage 2.

FIGS. 12 and 13 show fourth and fifth embodiments respectively of the steering assembly of the invention. In these variants, the steering assembly once again includes a male member 130 including a pawl 131 for engagement in a recess 23 of the ferrule 22. The steering assembly may be secured directly to the carriage as shown, or may be secured to the wheel mounting assembly which in turn is secured to the carriage.

In the fourth embodiment, the steering assembly includes a peddle member 132 projecting laterally from the male member 130. However in this embodiment, the peddle member 132 is integrally formed with a latching member 133 and secured to the male member 130 and about the frame member 4 by means of cooperating nuts 134 and 135 and a bolt 136. The frame member 4 thus acts as a fulcrum about which the male member 130, peddle member 132 and latch member 133 pivot, in the directions indicated by the arrows 137 and 138.

Depression of the peddle member 132 causes pivotal movement of the male member 130 about the frame member 4 towards a position in which the pawl 131 engages in the recess 23 of the ferrule 22 to prevent swivelling of the castor wheel 3.

Raising of the peddle member 132 causes pivoting of the male member 130 away from the ferrule 22, and also causes the pivotal movement of the latch member 133 towards the mounting assembly 8. The steering assembly may include a magnetic member 139 fixed to the latch member 133. The magnetic member 139 is attracted to the mounting assembly 8 when in close proximity thereto, to thereby retain the steering assembly in a position in which the male member 130 is at a distal position from the ferrule 2.

In the fifth embodiment of FIG. 13, the steering assembly may include a latching plate 140 or other releasable engagement device, mounted to the carriage for engagement with one end of the latch member 133. Upon pivoting of the steering assembly about a fixed point of the carriage such as frame member 4, an end 141 of the latch member 133 engages and is retained by the latching plate 140, thereby maintaining the male member 130 in a position in which the pawl 131 is disengaged from the recess 23 of the ferrule 22. Disengagement of the end 141 of the male member 133 from the latching plate 140, by depression of touch pads 150, in the direction of arrow 151 and causing movement of the second arm 133 in the direction of arrow 155, causes pivotal movement of the male member 130 towards a position in which the pawl 131 is engaged in the recess 23, and the swivelling of the castor wheel 3 prevented.

In order to disengage the pawl 131 from recess 23, touch pad 152 is depressed in the direction of arrow 153, thereby causing the pivotal movement of the male member 130 in the direction of arrow 154 and pawl 131 out of engagement and latching end 141 into engagement with latching plate 140, thereby retaining the pawl in the disengaged position.

In the embodiment shown in FIGS. 14-16, an alternative mounting structure is shown. In this embodiment, the steering assembly 200 may include a shuttle 202 slidingly mounted with respect to the castor bearing 204. The caster wheel 206 includes a skirt 208 mounted to the frame of the trolley by means of a wheel mounting assembly which includes bearing 204 and retaining rod 212. Retaining rod 212 engages with the bearing assembly 214 of bearing 204. In this embodiment, the skirt 208 is retained within inner race 216 for rotation about bearing casing.

In the embodiment, the shuttle 202 is fitted to the skirt 208 and is provided with a pawl which slidingly engages with an indexing slot 212 in the bearing casing 214 of the bearing 204.

The shuttle 202 is provided with actuators 218, 220 which provide a larger surface area for contact to engage and disengage the pawl of the shuttle with the indexing slot of the bearing. The actuators 218, 220 may be shaped so as that contact from the forward or lateral directions will urge the pawl into engagement with the indexing slot. A suitable shape is the arcuate shape shown. By contacting 218, the shuttle slides in the direction of arrow 222 and engages pawl 210 with indexing slot 212. The pawl is disengaged and the castor freed to rotate by contacting and sliding shuttle 224 in the direction of arrow 224.

When in the locked position, a bias such as locking spring 226 is attached by rivot 229 to the shuttle 202 at one end and to the skirt 208 at bracket 228. In order to retain the shuttle in the unlocked position, a dimple 232 is provided in the underside of the shuttle 202 to engage with a detent spring 230 secured by means of a rivot to the skirt The detent spring is in the form of a resilient flange.

1. A steering assembly for use with a trolley, the trolley including a carriage and at least one castor wheel swivel-mounted about a vertical axis, the steering assembly including:
co-operating wheel blocking members mounted respectively to a fixed mounting on the carriage or a wheel mounting assembly and the castor wheel; and
actuation means for causing the selective engagement of the co-operating wheel blocking members so as to prevent swiveling of the castor wheel.

2. The steering assembly of claim 1, wherein the wheel blocking members include a first wheel blocking member comprising a ferrule having a recess, and a second wheel blocking member comprising a pawl for engagement in that recess.

3. The steering assembly of claim 2, wherein the first wheel blocking member is mounted above the horizontal axis of the castor wheel.

4. The steering assembly of claim 3, wherein the second wheel blocking member, is directly mounted to the carriage or wheel mounting assembly by means of a bracket slidably mounted to the carriage or wheel mounting assembly.

5. The steering assembly of claim 4, wherein the bracket is slidably movable between a first position in which the bracket facilitates engagement of the wheel blocking members and a second position in which the bracket prevents engagement of the wheel blocking members.

6. The steering assembly of claim 5, further comprising actuation means for causing displacement of the bracket between the first and second position.

7. The steering assembly of claim 6, wherein the actuation means includes a cam lever pivotably mounted to the carriage and bearing upon the bracket upon rotation of the cam to displace the bracket towards the second position.

8. The steering assembly of claim 7, wherein the actuation means further includes a pushing mechanism to enable the bracket to be slidably moved to the second position.

9. The steering assembly of claim 8, wherein the pushing mechanism is a pushing plate provided at one end of the bracket.

10. The steering apparatus of claim 9, wherein the pushing plate is integrally formed with the bracket.

11. The steering assembly of claim 10, wherein at least one of the cam lever and the pushing mechanism is operated by contact with an adjacent trolley.

12. The steering assembly of claim 5, further comprising biasing means for biasing the bracket towards the first position.

13. The steering assembly of claim 12, wherein the biasing means includes one or more resilient members mounted between the bracket and the carriage.

14. The steering assembly of claim 2, wherein the second blocking member is directly mounted to the carriage or wheel mounting assembly.

15. The steering assembly of claim 14, wherein the castor wheel is mounted so as to be movable relative to the carriage between a first position in which the bracket facilitates engagement of the wheel blocking members, and a second position in which the bracket prevents engagement of the wheel blocking members.

16. The steering assembly of claim 1, wherein the carriage and castor wheel are caused to move towards the first position by application of force to the carriage.

17. The steering assembly of claim 2, wherein the second wheel blocking member is pivotably mounted to the carriage or wheel mounting assembly so as to be movable between a first position causing engagement of the wheel blocking members and a second position in which engagement of the wheel blocking members is prevented.

18. The steering assembly of claim 17, wherein the second wheel blocking member is pivotably mounted to the carriage or wheel mounting assembly by means of a latching mechanism.

19. The steering assembly of claim 18, wherein the latching mechanism includes a latch device for retaining the second wheel blocking member in either the first or second position.

20. The steering assembly of claim 19, wherein the second wheel blocking member is provided with a first arm having said pawl for engagement with said recess and a second arm for engagement with said latching device.

21. The steering device of claim 20, wherein the engagement of the second arm of the second wheel blocking member with the latch device retains the wheel blocking members in the disengaged position.

22. The steering assembly of claim 21, wherein the latch device includes a magnet.

23. The steering assembly of claim 21, wherein the latch device includes a latch plate.

24. The steering assembly of claim 17, wherein the actuation means includes a peddle member projecting from the second wheel blocking member.

25. The steering assembly of claim 24, wherein the peddle member is latched by the latch device in either the first or second position.

26. The steering assembly of claim 24, wherein the depression of the peddle member releases the second wheel blocking member and causes engagement of the wheel blocking members.

27. (canceled)
